(19) United States
(12) Patent Application Publication
(10) Pub. No.: US 2004/0221457 A1
(43) Pub. Date: Nov. 11, 2004

(54) Sheath for a machete

(76) Inventor: Wen-Chih Shen, Pingtung (TW)

Correspondence Address: BACON & THOMAS, PLLC, 625 SLATERS LANE, FOURTH FLOOR, ALEXANDRIA, VA, 22314

(21) Appl. No.: 10/429,791

(22) Filed: May 6, 2003

(51) Int. Cl. B26B 3/06

(52) U.S. Cl. 30/151; 30/298.4

(57) ABSTRACT

A machete sheath includes a first sheet and a second sheet securely connected to the first sheet. An L-shaped opening is defined between the first and second halves and an extension plate is formed on the peripheral edge of the second sheet along the L-shaped opening.

### BACKGROUND OF THE INVENTION

1. Field of the Invention

The present invention relates to a sheath, and more particularly to a machete sheath having an L-shaped opening defined in a peripheral edge of the sheath to allow the machete to slide into the sheath from the L-shaped opening.

2. Description of Related Art

With reference to FIGS. 4 and 5, a conventional sheath (50) normally has a somewhat rectangular contour and is provided with an opening (51) to allow a blade to slide into the sheath (50). However, no matter what the shape of the knife is, the sheath (50) shape maintains the same. That is, if the knife is a machete (60) with a pointed edge (61) to correspond to the opening (51), after the machete (60) is received in the sheath (50) from the opening (51), there is no way for people to tell what the shape of the “knife” is. Furthermore, when the machete (60) is to be received in the sheath (50), the user has to align the pointed edge (61) with the opening (51) to slide the machete (60) into the sheath (50). During the alignment process, it is very possible that the user might cut himself. Once the machete (60) is received in the sheath (50), people can not appreciate the beauty of the machete (60) without pulling out the machete (60) from the sheath (50).

To overcome the shortcomings, the present invention tends to provide an improved machete sheath to mitigate the aforementioned problems.

### SUMMARY OF THE INVENTION

The primary objective of the present invention is to provide an improved machete sheath to allow the user to easily store the machete in the sheath without worrying about being hurt during the receiving process.

Another objective of the present invention is to provide an extension plate along a side face of the L-shaped opening so that the machete is able to be easily slid into the sheath by placing the edge of the machete on the extension before the machete is slid into the sheath.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the sheath of the present invention, wherein a machete is shown for easy explanation of the use of the sheath;

FIG. 2 is a side view showing the edge of the machete is placed on the extension plate before the machete is received in the sheath;

FIG. 3 is a side view showing that the machete is slid into the sheath from the L-shaped opening;

FIG. 4 is a perspective view of a conventional sheath for a machete; and

FIG. 5 is a side view showing that the machete is received in the conventional sheath.

### DETAILED DESCRIPTION OF THE PREFERRED EMBODIMENT

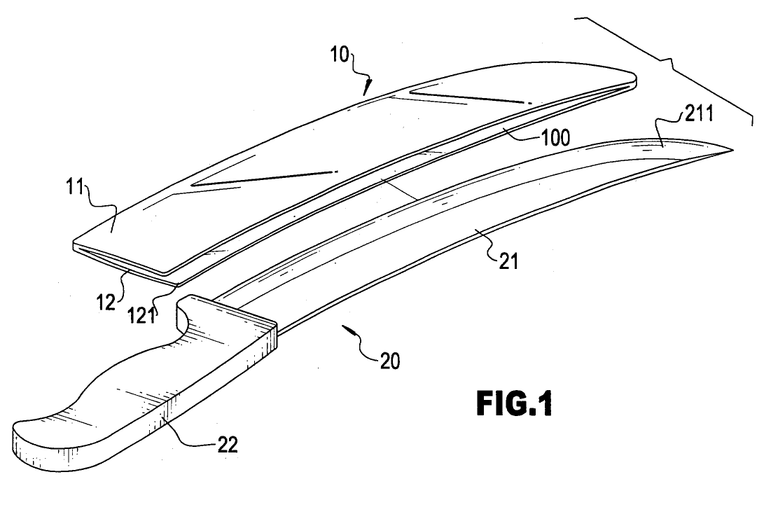

With reference to FIG. 1, the sheath (10) in accordance with the present invention is composed of a first sheet (11) having three side faces and a second sheet (12) having three side faces. A side face of the first sheet (11) is securely connected to a corresponding one of the three side faces, such that two side faces of the first sheet (11) and the second sheet (12) are not connected to each other to form an L-shaped opening (100). An extension plate (121) is formed on a peripheral edge of the second sheet (12) along the L-shaped opening (100). Therefore, the machete (20) having an arcuate body (21) with a sharp edge (211) and a handle (22) is able to be received in the sheath (10).

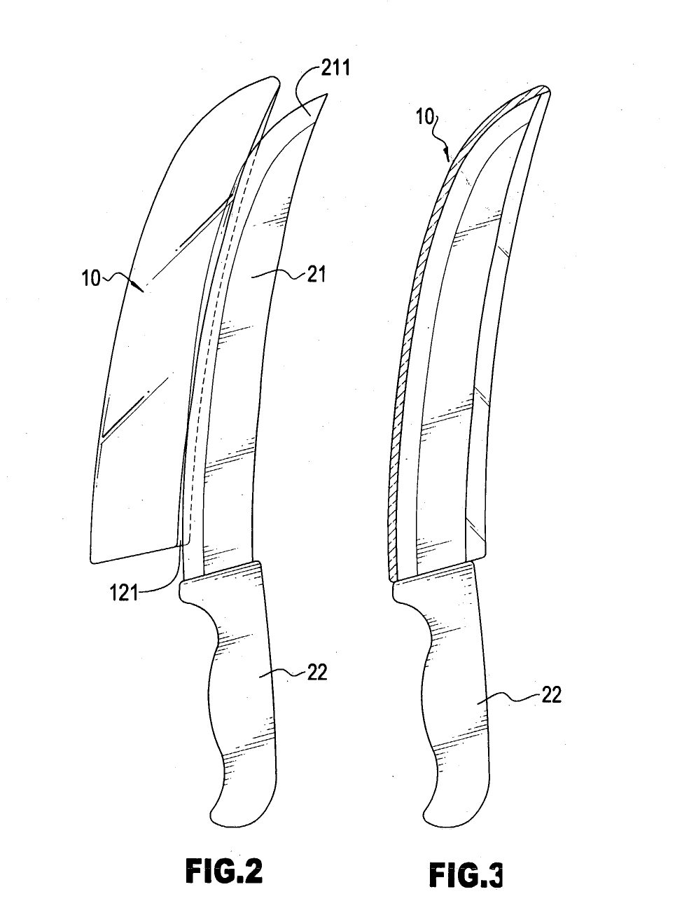

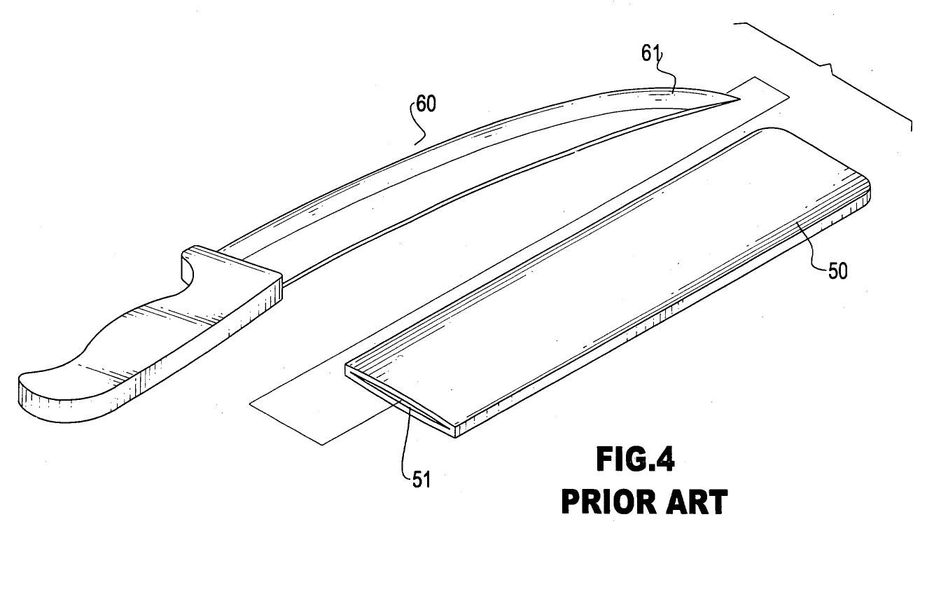

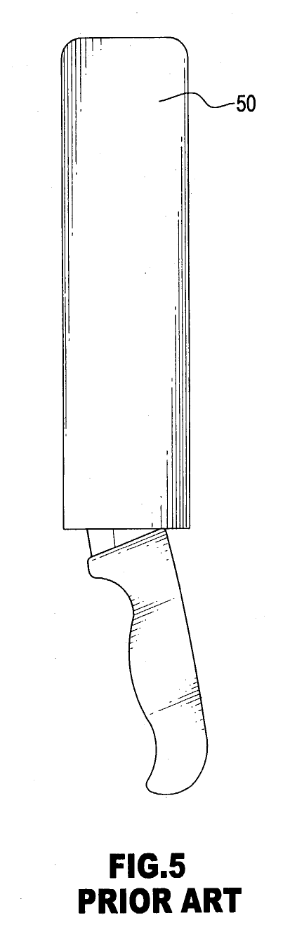

With reference to FIGS. 2 and 3, before the machete (20) is received in the sheath (10), the sharp edge (211) of the machete (20) is placed on the extension plate (121) to avoid any accidental injury to the user. Then, the user may slide the machete (20) in the sheath (10) from the L-shaped opening (100).

It is noted that after the machete (20) is received in the sheath (10), not only the contour of the machete (20) is able to be observed, but also the beauty of the machete (20) may be appreciated when the first and second sheets (11,12) are made of transparent material.

From the foregoing description, the sheath of the present invention has the following advantages:

Easy to Operate

When the machete is received in the sheath, the machete is first placed on the extension plate to avoid any accidental injury to the user.

Convenient to Observe

After the machete is received in the sheath, because the sheath is made of transparent material, the observer is still able to appreciate the beauty of the machete.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A machete sheath comprising:
a first sheet having three side faces;
a second sheet having three side faces, wherein a side face of the three side faces of the first sheet is securely connected to a corresponding one of the three side faces of the second sheet while an L-shaped opening having a tapered thickness is formed between the remaining two side faces of the three side faces of the first sheet and the other two side faces of the three side faces of the first sheet;
an extension plate is formed on one of the three side faces of the second sheet along the L-shaped opening; and
wherein the first and second sheets each have respective thickness that is substantially similar to that of a machete received in the L-shaped opening, and the first and second sheets are made of a transparent material.

2. (Cancelled)
